(19) United States
(12) Patent Application Publication
(10) Pub. No.: US 2013/0125196 A1
(43) Pub. Date: May 16, 2013

(54) Method and apparatus for combining encryption and steganography in a file control system

(71) Applicant: William M. Shapiro, Palo Alto, CA (US)

(72) Inventor: William M. Shapiro, Palo Alto, CA (US)

(21) Appl. No.: 11/132,923

(22) Filed: May 18, 2005

(51) Int. Cl. G06F 21/60

(52) U.S. Cl. CPC G06F 21/602
USPC 726/1

(57) ABSTRACT

One embodiment of the present invention provides a system that improves security of a file control system. During operation the system receives a request from a user to decrypt a file. The system then decrypts the file. Next, the system adds a watermark to the decrypted file which allows the decrypted file to be subsequently traced back to the origin of the decrypted file, thereby improving security of the file control system. Note that the watermark can include a user identifier, an Internet Protocol (IP) address associated with the user, a hardware address or identifier associated with the user, a timestamp, or any other information that can be used to identify the origin of the decrypted file.

### BACKGROUND

1. Field of the Invention

The present invention relates to securing digital information. More specifically, the present invention relates to a method and apparatus for improving security of a file control system by combining encryption with steganography.

2. Related Art

The global costs incurred from security breaches can run into billions of dollars annually, and the cost to individual companies can be severe, sometimes catastrophic. Consequently, as organizations move more business processes online, protecting sensitive information against such security breaches is becoming an increasingly critical task.

Some security solutions attempt to protect information only at the storage location or during transmission. However, these solutions do not provide protection over the information's entire lifecycle. Specifically, in these solutions, when the information reaches a recipient, the protection is lost, and the information can be intentionally or unintentionally sent to and viewed by unauthorized recipients.

An improved solution uses a Document Control System (DCS) to protect information (e.g., file or document) throughout the information's lifecycle. Specifically, in addition to controlling access to a file that contains sensitive information, a DCS often provides additional functionality, such as auditing user actions, allowing fine-grained permissions to be specified for a file (e.g., permission to print, copy, etc) and the ability to set an expiration date for a file or to revoke permissions after the file has been distributed.

Unfortunately, DCSs have several drawbacks. Specifically, DCSs can make offline access to files inconvenient because they may require users to first open the document online before allowing users to access the document offline. Furthermore, DCSs often impose time limits on offline accesses. Finally, since DCSs typically encrypt files, they can prevent files from being indexed and they can also complicate long-term archival.

Hence, what is needed is a method and an apparatus for improving security of a file control system without the above-mentioned drawbacks.

### SUMMARY

One embodiment of the present invention provides a system that improves security of a file control system. During operation the system receives a request from a user to decrypt a file. The system then decrypts the file. Next, the system adds a watermark to the decrypted file which allows the decrypted file to be subsequently traced back to the origin of the decrypted file, thereby improving security of the file control system. Note that the watermark can include a user identifier, an Internet Protocol (IP) address associated with the user, a hardware address or identifier associated with the user, a timestamp, or any other information that can be used to identify the origin of the decrypted file.

In a variation on this embodiment, the system can authenticate the user. Note that if the authentication fails, the system can report an error.

In a variation on this embodiment, the system decrypts the file by sending user authentication information to a server, and by receiving a key from the server that can be used to decrypt the file.

In a variation on this embodiment, the system can include one or more of the following entities: a document control system; a server, such as an Adobe® LiveCycle Policy Server; a document editor, such as an Adobe® Acrobat editor; a document reader, such as an Adobe® Reader; or a proxy server that acts as an intermediary between a client (such as a mobile device) and a server.

In a variation on this embodiment, the system can receive a request to encrypt a file. Further, the system can also receive a security policy associated with the file which specifies that, in the event the file is decrypted by a user, a watermark should be added to the decrypted file. Next, the system can encrypt the file and associate the security policy with the encrypted file.

In a further variation on this embodiment, the security policy can specify: whether the user can decrypt the file; whether the user can copy the contents of the file; whether the user can print the contents of the file; whether the user can edit the contents of the file; an encryption technique to encrypt the file; a key used for encrypting the file; or a digital watermarking technique to add a digital watermark to the file.

Another embodiment of the present invention provides a system that improves security of a file control system. During operation the system receives a request from a user to decrypt a file. The system then determines a security policy for the file, which specifies the operations that the user can perform on the file. Next, the system checks whether the security policy allows the user to decrypt the file, and if so, the system decrypts the file. The system then checks whether the security policy requires that a watermark be added whenever the file is decrypted. If so, the system adds a watermark to the decrypted file which allows the decrypted file to be subsequently traced back to the origin of the decrypted file, thereby improving security of the file control system. Note that the watermark can be an invisible watermark that is robust against data manipulation or tampering. Furthermore, the watermark can include a user identifier, an Internet Protocol (IP) address associated with the user, a hardware address or identifier associated with the user, a timestamp, or any other information that can be used to identify the origin of the decrypted file.

### BRIEF DESCRIPTION OF THE FIGURES

FIG. 1 illustrates a file control system in accordance with an embodiment of the present invention.

FIG. 2 illustrates how a file can be secured in a file control system in accordance with an embodiment of the present invention.

FIG. 3 presents a flowchart that illustrates a process for decrypting a file and adding a watermark to the file in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, magnetic and optical storage devices, such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as a LAN, a WAN, or the Internet.

### File Control System

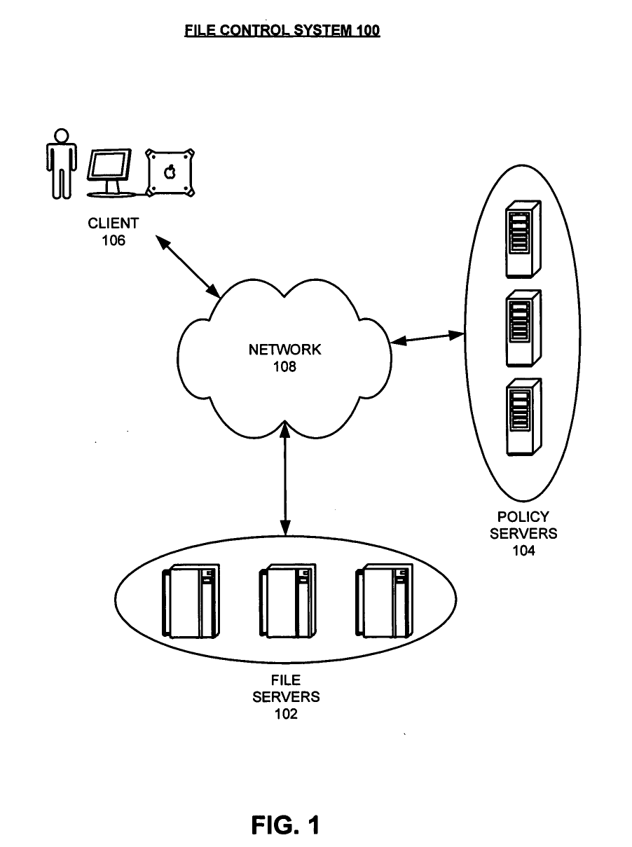

FIG. 1 illustrates a file control system in accordance with an embodiment of the present invention.

File control system 100 can include network 108, file servers 102, policy servers 104, and client 106. Note that a “file” can generally refer to a collection of information that is treated as a single entity. For example, a file can be a document or a multimedia file.

Network 108 can facilitate communication between file servers 102, policy servers 104, and client 106. Network 108 can generally include any type of wire or wireless communication channel capable of coupling together computing nodes. This includes, but is not limited to, a local area network, a wide area network, or a combination of networks. Network 108 can also be a combination of public and private networks. In one embodiment of the present invention, network 108 can include the Internet. Note that a file server and a policy server can be located on the same physical device.

File servers 102 can store files using a variety of data storage systems. These include, but are not limited to, systems based upon magnetic, optical, and magneto-optical storage devices, as well as storage devices based on flash memory and/or battery-backed up memory.

Policy servers 104 can associate a security policy with a file. In general, a security policy specifies the operations that a user can perform on a file. In one embodiment, a policy server can be an Adobe® LiveCycle Policy Server.

Client 106 can generally include any type of computing device. This includes, but is not limited to, a computer system based on a microprocessor, a video camera, a Personal Digital Assistant (PDA), a personal organizer, a laptop computer, or a mobile phone. In one embodiment, client 106 is a computing device capable of reading or editing a file. Specifically, client 106 can be any device that is capable of running Adobe® Acrobat or Adobe® Reader software.

Note that these embodiments of a file control system have been described for purposes of illustration. They are not intended to be exhaustive or to limit the present invention to the forms disclosed. Accordingly, many modifications and variations will be readily apparent to practitioners skilled in the art. For example, file servers 102 and policy servers 104 can be combined into a single entity that resides on a single physical device. Conversely, in another embodiment, a single file server (or policy server) can refer to a single logical entity that is implemented in a distributed fashion using a number of physical devices.

### Document Control Systems and Digital Watermarking

A Document Control System is a type of file control system that encrypts files and associates security policies with files that describe usage rights for the files. In order to open a controlled file, a user must first authenticate against a server. The server then determines if the user has permission to access the file. If the user is permitted to access the file, the server releases a key that can be used to decrypt the file. In addition to controlling accesses to a file, a DCS often provides additional functionality, such as auditing user actions, allowing fine-grained permissions to be specified for file (e.g., permission to print, copy, etc) and the ability to set an expiration date for a file or to revoke the file after it has been distributed. However, the power of a DCS also comes at a price. Document Control Systems impose several constraints, such as limiting the ability of users to access files when offline, preventing files from being indexed (since they are encrypted), and complicating long-term archival of files due to key management issues.

Digital watermarking, although much less powerful, does not suffer from these drawbacks. Digital watermarking (or steganography) typically involves embedding information in a file that allows the origin of the file to be traced. Digital watermarks can be used to trace a malicious recipient who uses the file an unauthorized way. Furthermore, digital watermarks can typically be added to a file without modifying the format of the file or imposing any additional constraints on the recipients (such as requiring them to connect to a server via a network). Digital watermarks are typically used to prevent piracy of digital multimedia content. Moreover, digital watermarks are often added in a way which makes them robust to modification of the file, i.e., it is very difficult to remove the watermark by modifying the file (e.g., editing it, removing pages, etc). Additionally, digital watermarks are typically hidden so that a malicious user cannot easily find the watermarks in a file.

Present systems typically either use only encryption or only steganography to secure documents. Unfortunately, each approach when used alone has drawbacks. Specifically, encryption imposes many constraints on file distribution and access. On the other hand, steganography does not provide the level of security that encryption provides.

One embodiment of the present invention combines encryption with steganography to improve security of a file control system. Specifically, one embodiment allows a security policy to specify that a digital watermark be added to the file whenever the file is decrypted. In particular, the digital watermark can contain information that can be used to trace the decrypted file back to its origin.

Note that, a file control system that only uses encryption loses control of the document once the document is decrypted. Hence, if a sensitive document is leaked, encryption-only based systems cannot trace the document back to the origin of the leak. This is undesirable because it prevents malicious users from being traced and apprehended.

Likewise, file control systems that only use digital watermarking typically do not provide the same level of security as encryption.

Note that simply adding a digital watermark to a file (for example, during creation) and then encrypting the file does not substantially improve security of a file control system. Specifically, in this approach, the watermark usually carries information that is known during file creation. For example, the digital watermark may contain information that identifies the copyright owner. Unfortunately, such digital watermarks do not improve security of a file control system because they do not contain any information that can be used to trace the decrypted file back to its origin, i.e., the point at which the file was decrypted.

### Process of Securing a File

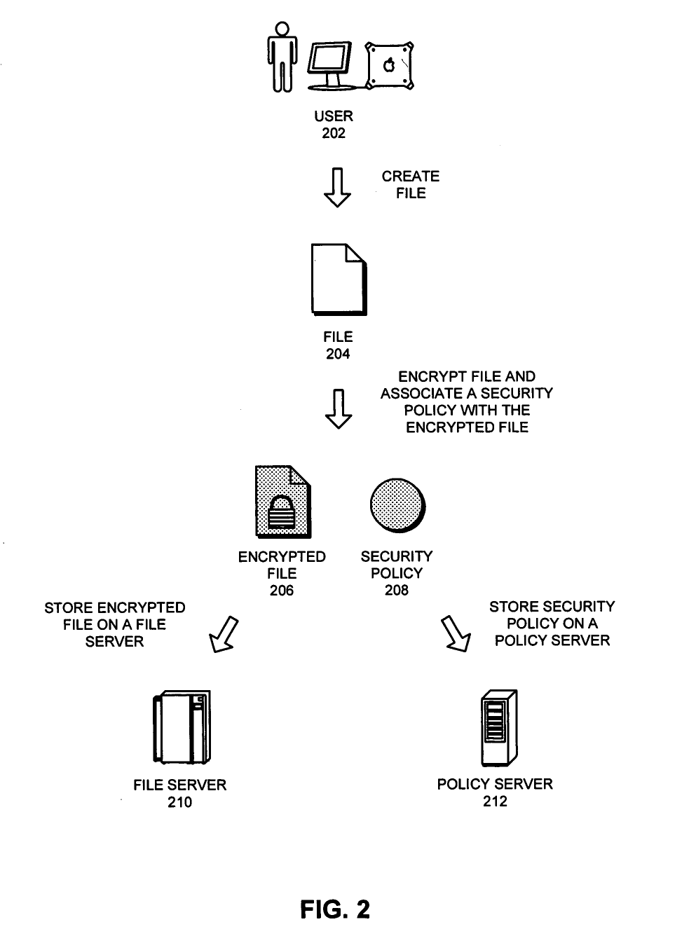

FIG. 2 illustrates how a file can be secured in a file control system in accordance with an embodiment of the present invention.

The process of securing a file typically begins when a user, such as user 202, creates a file, such as file 204, which needs to be secured.

User 202 can request the file control system (e.g., a DCS) to secure file 202. In one embodiment, the system encrypts file 204 to generate encrypted file 206. The system also creates security policy 208 which specifies the operations a user can perform on encrypted file 206. For example, security policy 208 can specify whether a user is allowed to decrypt encrypted file 206. Note that security policy 208 can also specify operations that can be performed on the decrypted version of the file. For example, security policy 208 can specify whether a user can print the decrypted version of file 206 or not.

Note that the above-described embodiments of a security policy have been presented for purposes of illustration. They are not intended to be exhaustive or to limit the present invention to the forms disclosed. Accordingly, many modifications and variations will be readily apparent to practitioners skilled in the art. For example, a security policy can specify: whether the user can decrypt the file; whether the user can copy the contents of the file; whether the user can print the contents of the file; whether the user can edit the contents of the file; an encryption technique to encrypt the file; a key used for encrypting the file; and a digital watermarking technique to add a digital watermark to the file.

The system can then store encrypted file 206 on file server 210, and store security policy 208 on policy server 212. Further, the system can associate encrypted file 206 with security policy 208, thereby allowing the system to subsequently determine encrypted file 206's security policy. In one embodiment, this association can be stored on policy server 212.

Note that the system does not have to create a new security policy every time it encrypts a file. For example, the system can associate encrypted file 206 with an existing security policy.

Further, in one embodiment, the file control system may require only a specific type of client software to be used to perform operations on the file. This is because, in certain cases, the client may be required to enforce the security policy. In such cases, the system needs to ensure that the software running on the client can properly enforce the security policy. For example, the security policy can require the client software to add a digital watermark to a document whenever it is decrypted. Note that if the document is decrypted using a generic document reading software, the system may not be able to guarantee that the generic document reading software will add a watermark to the document after it has been decrypted. Specifically, in one embodiment, the system may require that the client use Adobe® Acrobat or Adobe® Reader software to decrypt and view the document.

Moreover, note that the encryption, decryption, and digital watermarking can be performed using a number of techniques. For example, the system can use symmetric or asymmetric keys to perform encryption/decryption. Furthermore, when the client requests a file to be decrypted, the client can receive a key, which the client can then uses to decrypt the file. In another embodiment, the client can directly receive the decrypted file from a server in response to a decryption request. In yet another embodiment, the client can send a copy of the encrypted file to a server, which can then decrypt the file and send it back to the client. Note that communications between the server and the client can be performed in a secure fashion.

Similarly, it will be apparent that a number of techniques can be used to add a digital watermark to a file. For example, the watermark can be added by the client after the client decrypts the file. In another embodiment, the server can decrypt and add a watermark to the file. In yet another embodiment, the server can decrypt the file and send it to the client, which can then add a watermark. It will be apparent that a number of permutations and combinations of the above-described techniques can be used to add a watermark to a file whenever the file is decrypted.

Note that, in order to add a digital watermark that can be used to identify a malicious user, the system may need to authenticate the user before adding the digital watermark. Because otherwise, a malicious user can impersonate as a legitimate user and defeat the whole purpose of adding digital watermarks to help identify malicious users.

Furthermore, it will be apparent to one skilled in the art that a user can be authenticated using a variety of techniques. Specifically, in one embodiment, the policy server can authenticate a user. In another embodiment, the system can use a separate authentication server to authenticate a user.

Furthermore, the system can also include computing devices that act as intermediaries between clients and servers. Specifically, the system can include a proxy server that forwards the decrypted file to a client which may be incapable of decrypting a file. For example, a mobile phone may not have the computing capability to communicate with a file control system and/or decrypt a file. In such situations, a proxy server can help by authenticating the mobile phone user and serve as an intermediary between the mobile phone and the file control system.

### Process of Decrypting a File and Adding a Watermark

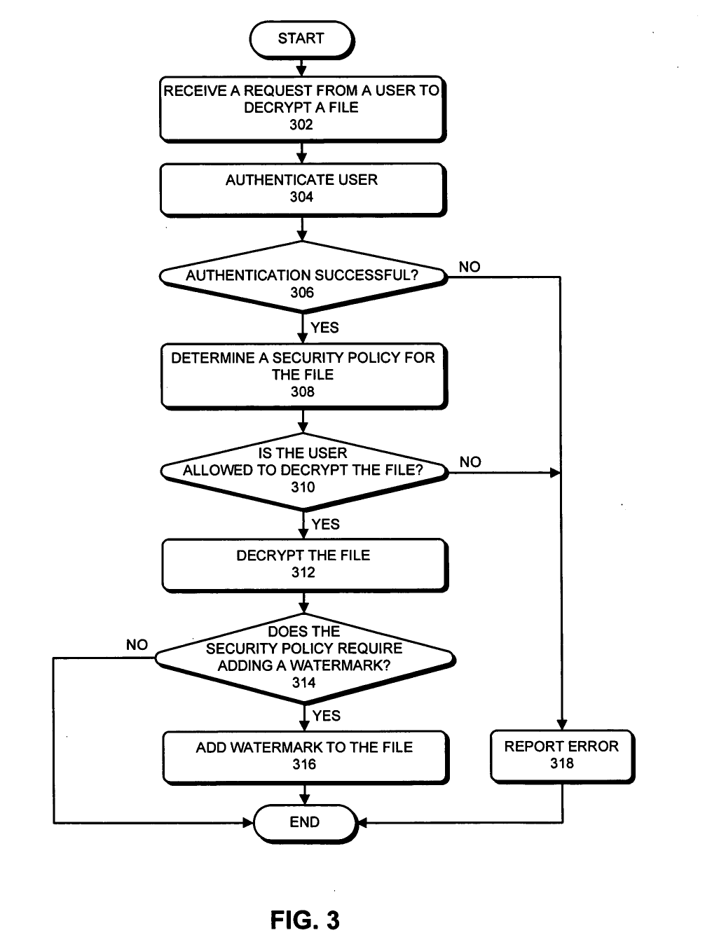

FIG. 3 presents a flowchart that illustrates a process for decrypting a file and adding a watermark to the file in accordance with an embodiment of the present invention.

The process typically begins by receiving a request from a user to decrypt a file (step 302). In one embodiment, the request can be received at a client. In another embodiment, the request can be received at a server.

The system then authenticates the user (step 304). Note that the system can use a number of well-known techniques to authenticate the user. For example, in one embodiment, the client (or server) can use RADIUS (Remote Authentication Dial In User Service) to authenticate users.

If the user successfully authenticates, the system determines a security policy for the file (step 306).

Recall that a security policy specifies the operations that the user can perform on the file. Furthermore, the association between a file and a security policy can be maintained using a variety of techniques. For example, in one embodiment, a data structure can be maintained on the policy server that associates each file with a security policy. In another embodiment, the security policy for a file can be stored in the metadata region of the file, which may be stored on a file server. Furthermore, note that the client can determine the security policy for a file by sending a request to a policy server. The client can then receive a response from the policy server that contains information that can be used to determine the security policy associated with the file.

Note that, if the authentication fails, the system can report an error (step 318).

Next, the system checks whether the user is allowed to decrypt the file based on the security policy (step 308). In one embodiment, the client can check whether the user is allowed to decrypt the file based on information contained in the security policy. In another embodiment, a server can use information contained in the security policy to determine whether the user is allowed to decrypt the file.

If the user is allowed to decrypt the file, the system then decrypts the file (step 310). Note that in one embodiment, the file can be decrypted by the client. In another embodiment the file can be decrypted by the server.

Further, in one embodiment, the security policy can specify the encryption/decryption technique to use for encrypting/decrypting the file. Further, the security policy can also store the encryption/decryption key. Additionally, in one embodiment, the system can perform an integrity check on the decrypted file to ensure that the proper decryption key was used.

On the other hand, if the user is not allowed to decrypt the file, the system reports an error (step 312).

The system then determines whether the security policy requires that a watermark be added whenever the file is decrypted (step 314). In one embodiment, the client can check whether the security policy requires that a watermark be added to the file whenever the file is decrypted. In another embodiment, the server can use information contained in the security policy to determine whether a watermark needs to be added to the file whenever the file is decrypted.

If the security policy requires a watermark to be added to the file, the system adds a watermark to the file (step 316). Note that a client (or server) can add a digital watermark to the file. Specifically, the watermark can contain information that can be used to trace the file back to the point when/where it was decrypted. Further, it will be apparent to one skilled in the art that a number of techniques can be used to add a digital watermark to the file. Specifically, in one embodiment, the system adds an invisible digital watermark that is robust against manipulation or tampering of the file.

Note that the foregoing descriptions of embodiments of the present invention have been presented only for purposes of illustration and description. They are not intended to be exhaustive or to limit the present invention to the forms disclosed. Accordingly, many modifications and variations will be readily apparent to practitioners skilled in the art. Additionally, the above disclosure is not intended to limit the present invention. The scope of the present invention is defined by the appended claims.

1. A method for improving security of a file control system, the method comprising:
performing, by a computer:
receiving a request from a user to view a file, and in response:
accessing a security policy associated with the file to determine whether the security policy authorizes the user to view a decrypted version of the file, wherein the security policy also specifies:
whether the user is permitted to create an unencrypted copy of content from the file; and
adding a watermark to the unencrypted copy of the content from the file whenever the file is decrypted, wherein the added watermark contains information usable to trace the unencrypted copy of the content from the file back to an origin of the decrypted version of the file;
decrypting the file to permit the user to view the decrypted version of the file in response to determining that the security policy authorizes the user to view the decrypted version of the file, wherein said decrypting comprises said adding the watermark to the unencrypted copy of the content from the file; and
receiving another request from the user to create a copy of content from the file, and in response:
determining whether the security policy permits the user to create an unencrypted copy of the content from the file;
ensuring that an unencrypted copy of the content from the file contains the watermark specified by the security policy if the security policy permits the user to create an unencrypted copy of the content from the file, wherein said ensuring comprises said adding the watermark to the unencrypted copy of the content from the file; and
preventing an unencrypted copy of the content from the file from being created if the security policy does not permit the user to create an unencrypted copy of the content from the file.

2. The method of claim 1, further comprising:
receiving another request from another user to decrypt the file;
determining whether the security policy associated with the file authorizes the another user to access the file;
reporting an error in response to determining that the security policy does not authorize the another user to access the file.

3. The method of claim 1, wherein decrypting the file involves:
sending user authentication information to a server; and
receiving a key from the server that can be used to decrypt the file.

4. The method of claim 1, wherein the watermark includes a user identifier, an Internet Protocol (IP) address associated with the user, a hardware address or identifier associated with the user, a timestamp, or any other information that can be used to identify the origin of the decrypted version of the file.

5. The method of claim 1, wherein the method is performed by:
a document control system;
a policy server;
a document editor;
a document reader; or
a proxy server that acts as an intermediary between a client and a server.

6. The method of claim 1, further comprising:
creating a security policy and associating the security policy with the file, wherein the security policy specifies that, in the event the file is decrypted, a watermark should be added to the decrypted file; and
encrypting the file in response to receiving a request to encrypt the file, wherein the encrypted file remains associated with the security policy.

7. The method of claim 6, wherein the security policy specifies:
whether a user can decrypt the file;
whether a user can copy the contents of the file;
whether a user can print the contents of the file;
whether a user can edit the contents of the file;
an encryption technique to encrypt the file;
a key used for encrypting the file; or
a digital watermarking technique to add the watermark to the file as a digital watermark.

8. A non-transitory computer-readable storage medium storing instructions that when executed by a computer cause the computer to perform a method for improving security of a file control system, the method comprising:
receiving a request from a user to view a file, and in response:
accessing a security policy associated with the file to determine whether the security policy authorizes the user to view a decrypted version of the file, wherein the security policy also specifies:
whether the user is permitted to create an unencrypted copy of content from the file; and
adding a watermark to the unencrypted copy of the content from the file whenever the file is decrypted, wherein the added watermark contains information usable to trace the unencrypted copy of the content from the file back to an origin of the decrypted version of the file;
decrypting the file to permit the user to view the decrypted version of the file in response to determining that the security policy authorizes the user to view the decrypted version of the file, wherein said decrypting comprises said adding the watermark to the unencrypted copy of the content from the file; and
receiving another request from the user to create a copy of content from the file, and in response:
determining whether the security policy permits the user to create an unencrypted copy of the content from the file;
ensuring that an unencrypted copy of the content from the file contains the watermark specified by the security policy if the security policy permits the user to create an unencrypted copy of the content from the file, wherein said ensuring comprises said adding the watermark to the unencrypted copy of the content from the file; and
preventing an unencrypted copy of the content from the file from being created if the security policy does not permit the user to create an unencrypted copy of the content from the file.

9. The computer-readable storage medium of claim 8, further comprising:
receiving another request from another user to decrypt the file;
determining whether the security policy associated with the file authorizes the another user to access the file;
reporting an error in response to determining that the security policy does not authorize the another user to access the file.

10. The computer-readable storage medium of claim 8, wherein decrypting the file involves:
sending user authentication information to a server; and
receiving a key from the server that can be used to decrypt the file.

11. The computer-readable storage medium of claim 8, wherein the watermark includes a user identifier, an Internet Protocol (IP) address associated with the user, a hardware address or identifier associated with the user, a timestamp, or any other information that can be used to identify the origin of the decrypted version of the file.

12. The computer-readable storage medium of claim 8, wherein the method is performed by:
a document control system;
a policy server;
a document editor;
a document reader; or
a proxy server that acts as an intermediary between a client and a server.

13. The computer-readable storage medium of claim 8, further comprising:
creating a security policy and associating the security policy with the file, wherein the security policy specifies that, in the event the file is decrypted, a watermark should be added to the decrypted file, wherein the watermark contains information indicating when or where the file was decrypted; and
encrypting the file in response to receiving a request to encrypt the file, wherein the encrypted file is still associated with the security policy.

14. The computer-readable storage medium of claim 13, wherein the security policy specifies:
whether a user can decrypt the file;
whether a user can copy the contents of the file;
whether a user can print the contents of the file;
whether a user can edit the contents of the file;
an encryption technique to encrypt the file;
a key used for encrypting the file; or
a digital watermarking technique to add the watermark to the file as a digital watermark.

15. A computing device for improving security of a file control system, wherein the computing device comprises a processor configured to execute code for:
a receiving mechanism configured to receive a request from a user to view a file and to receive another request from the user to create a copy of content from the file;
a policy accessing mechanism configured to access a security policy associated with the file to determine whether the security policy authorizes the user to view a decrypted version of the file, wherein the security policy also specifies:
whether the user is permitted to create an unencrypted copy of content from the file; and
adding a watermark to the unencrypted copy of the content from the file whenever the file is decrypted, wherein the added watermark contains information usable to trace the unencrypted copy of the content from the file back to an origin of the decrypted version of the file;
a decrypting mechanism configured to decrypt the file to permit the user to view the decrypted version of the file in response to the receiving mechanism receiving a request from the user to view the file and in response to the policy accessing mechanism determining that the security policy authorizes the user to view the decrypted version of the file, wherein the decrypting mechanism is configured to perform said adding the watermark to the unencrypted copy of the content from the file whenever the decrypting mechanism decrypts the file; and
a content-copying mechanism configured to, in response to the receiving mechanism receiving another request from the user to create a copy of content from the file:
determine whether the security policy permits the user to create an unencrypted copy of the content from the file;
ensure that an unencrypted copy of the content from the file contains the watermark specified by the security policy if the security policy permits the user to create an unencrypted copy of the content from the file, wherein the decrypting mechanism is configured to perform said adding the watermark to the unencrypted copy of the content from the file whenever the decrypting mechanism decrypts the file; and
prevent an unencrypted copy of the content from the file from being created if the security policy does not permit the user to create an unencrypted copy of the content from the file.

16. The computing device of claim 15, wherein the decrypting mechanism is configured to:
send user authentication information to a server; and
receive a key from the server that can be used to decrypt the file.

17. The computing device of claim 15, wherein the watermark includes include a user identifier, an Internet Protocol (IP) address associated with the user, a hardware address or identifier associated with the user, a timestamp, or any other information that can be used to identify the origin of the decrypted version of the file.

18. The computing device of claim 15, wherein the code, when executed by the processor, also:
creates a security policy and associates the security policy with the file, wherein the security policy specifies that, in the event the file is decrypted, a watermark should be added to the decrypted file, wherein the watermark contains information indicating when or where the file was decrypted; and
encrypts the file in response to receiving a request to encrypt the file, wherein the encrypted file is still associated with the security policy.

19. The computing device of claim 18, wherein the security policy specifies:
whether a user can decrypt the file;
whether a user can copy the contents of the file;
whether a user can print the contents of the file;
whether a user can edit the contents of the file;
an encryption technique to encrypt the file;
a key used for encrypting the file; or
a digital watermarking technique to add the watermark to the file as a digital watermark.
